(19) United States
(12) Patent Application Publication
(10) Pub. No.: US 2011/0121728 A1
(43) Pub. Date: May 26, 2011

(54) APPARATUS AND METHOD FOR CONTROLLING LIGHT INTENSITY OF LAMP

(76) Inventor: Kin Ming Fung, Hong Kong (HK)

(21) Appl. No.: 12/952,220

(22) Filed: Nov. 23, 2010

Related U.S. Application Data
(60) Provisional application No. 61/263,827, filed on Nov. 24, 2009.

(51) Int. Cl. F21V 23/00

(52) U.S. Cl. 315/32

(57) ABSTRACT

An apparatus for controlling the light intensity of a lamp includes a remote control unit and a built-in module integrated with the lamp. The remote control unit includes a RF transmitter for transmitting a RF signal based on a user input. The built-in module includes a RF receiving module configured for receiving the RF signal from the remote control unit and a lamp driving module controlled by the RF receiving module and configured for controlling the light intensity of the lamp based on the RF signal. In adjusting the light intensity of the lamp, the built-in module is configured to change the light intensity from a current level to a preset level and then from the preset level to an adjusted level. A method for controlling the light intensity of a lamp is also provided.

### CROSS-REFERENCE TO RELATED APPLICATIONS

This application claims the benefit of U.S. Provisional Application No. 61/263,827, filed on Nov. 24, 2009; the contents of which is hereby incorporated by reference.

### FIELD OF THE PATENT APPLICATION

The present patent application relates to the control of light intensity of lamps and more particularly to an apparatus and a method for controlling the light intensity of a lamp in which a dimmer is used to create the change of intensity with a wired or wireless system.

### BACKGROUND

The controlling method of typical light control systems is to directly adjust the dimming level and the effect occurs proportionally to the adjusting amount. With wired or wireless control, the level of intensity is achieved by a difference in voltage applied to the bulb. In a typical light control system, the external receiver for a value control to the bulb is used as a part of the system. The external receiver is created individually and acts as a linking device for the controller and the bulb.

### SUMMARY

The present patent application is directed to an apparatus and a method for controlling the light intensity of a lamp. In one aspect, the present patent application provides an apparatus for controlling the light intensity of a lamp. The apparatus includes a remote control unit, the remote control unit including a RF transmitter for transmitting a RF signal based on a user input; and a built-in module integrated with the lamp, the built-in module including a RF receiving module configured for receiving the RF signal from the remote control unit and a lamp driving module controlled by the RF receiving module and configured for controlling the light intensity of the lamp based on the RF signal. In adjusting the light intensity of the lamp, the built-in module is configured to change the light intensity from a current level to a preset level and then from the preset level to an adjusted level.

The built-in module may be configured to change the light intensity from the current level to the preset level over a predetermined time interval and to change the light intensity from the preset level to the adjusted level over the predetermined time interval.

The built-in module may be configured to change the light intensity after a predetermined time interval of ignorance.

The built-in module may be configured to keep the light intensity at the preset level for a predetermined time interval before changing the light intensity from the preset level to the adjusted level.

The built-in module may be configured to change the light intensity in only one direction in any particular time interval.

The current level and the adjusted level may be higher than or equal to a cut-off level and the preset level may be higher than the cut-off level.

The built-in module may be configured to change the light intensity from a starting intensity level that is equal to 10% to 20% of the maximum intensity of the lamp.

In another aspect, the present patent application provides a method for controlling the light intensity of a lamp. The method includes transmitting a RF signal based on a user input through a remote control unit; receiving the RF signal with a RF receiving module; and controlling the light intensity of the lamp based on the RF signal with a lamp driving module controlled by the RF receiving module, the RF receiving module and the lamp driving module forming a built-in module integrated with the lamp. The light intensity of the lamp is changed from a current level to a preset level and then from the preset level to an adjusted level.

The light intensity may be changed from the current level to the preset level over a predetermined time interval, and may be changed from the preset level to the adjusted level over the predetermined time interval.

The light intensity may be changed after a predetermined time interval of ignorance.

The light intensity may be kept at the preset level for a predetermined time interval before being changed from the preset level to the adjusted level.

The light intensity may be changed in only one direction in any particular time interval.

The current level and the adjusted level may be higher than or equal to a cut-off level and the preset level may be higher than the cut-off level.

The light intensity may be changed from a starting intensity level that is equal to 10% to 20% of the maximum intensity of the lamp.

In yet another aspect, the present patent application provides an apparatus for controlling the light intensity of a lamp. The apparatus includes a remote control unit, the remote control unit including a RF transmitter for transmitting a RF signal based on a user input; and a built-in module integrated with the lamp, the built-in module including a RF receiving module configured for receiving the RF signal from the remote control unit, a lamp driving module controlled by the RF receiving module and configured for controlling the light intensity of the lamp based on the RF signal, and a power supply module configured for supplying a DC voltage to the RF receiving module and the lamp driving module. In adjusting the light intensity of the lamp, the built-in module is configured to change the light intensity from a current level to a preset level and then from the preset level to an adjusted level.

The apparatus may further include a rectification module connected to the power supply module and configured for transforming an AC power supply to a DC power supply.

The apparatus may further include an electromagnetic interference module connected with the rectification module and configured to reduce the electromagnetic interference to the apparatus.

### BRIEF DESCRIPTIONS OF THE DRAWINGS

FIG. 1A is a block diagram of a remote control unit for transmitting a RF signal in an apparatus for controlling the light intensity of a lamp according to an embodiment of the present invention.

FIG. 1B illustrates a built-in module for receiving the RF signal from the remote control unit and controlling the light intensity of a lamp in the embodiment as depicted in FIG. 1A.

FIG. 2 illustrates the change of the light intensity of the lamp when the light intensity is being adjusted by the apparatus for controlling the light intensity of a lamp in the embodiment as depicted in FIG. 1B.

### DETAILED DESCRIPTION

Reference will now be made in detail to a preferred embodiment of the apparatus and the method for controlling the light intensity of a lamp disclosed in the present patent application, examples of which are also provided in the following description. Exemplary embodiments of the apparatus and the method for controlling the light intensity of a lamp disclosed in the present patent application are described in detail, although it will be apparent to those skilled in the relevant art that some features that are not particularly important to an understanding of the apparatus and the method for controlling the light intensity of a lamp may not be shown for the sake of clarity.

Furthermore, it should be understood that the apparatus and the method for controlling the light intensity of a lamp disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

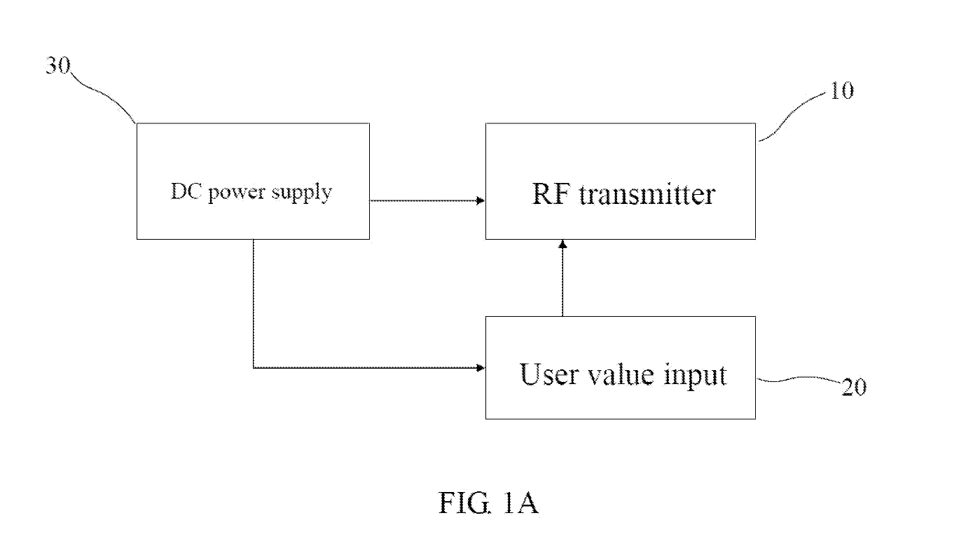

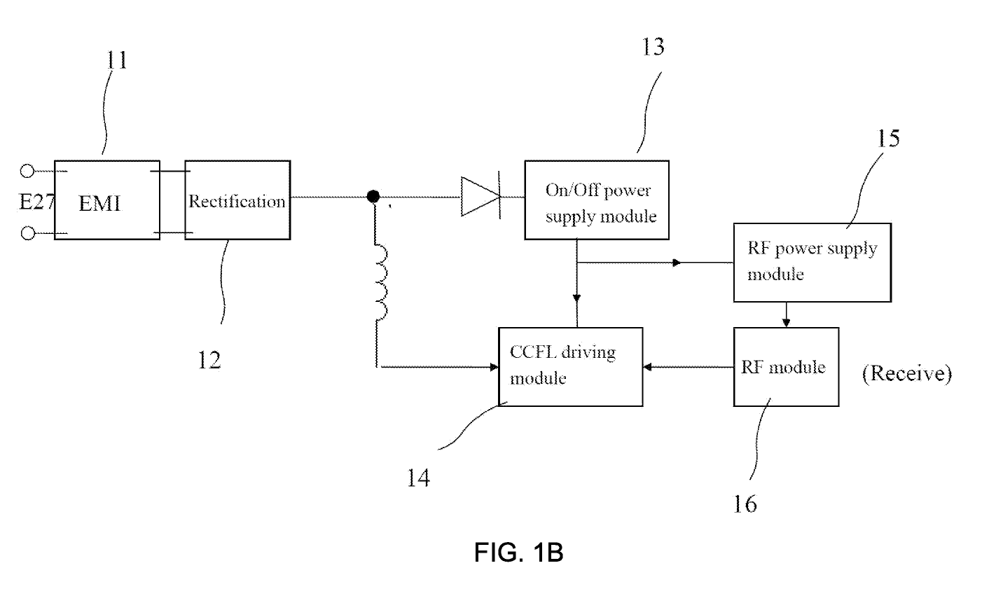

FIG. 1A is a block diagram of a remote control unit for transmitting a RF signal in an apparatus for controlling the light intensity of a lamp according to an embodiment of the present invention. Referring to FIG. 1A, the system is supplied by a DC power supply 30, and by an input of a user. A value may be entered to an input 20. The RF transmitter 10 receives the user input and emits a RF signal based on the user input to a built-in module so as to control the intensity of the lamp. The built-in module is hereafter described in more detail.

FIG. 1B illustrates a built-in module for receiving the RF signal from the remote control unit and controlling the light intensity of a lamp in the embodiment as depicted in FIG. 1A. Referring to FIG. 1B, the EMI (Electromagnetic Interference) module 11 is connected to an E27 circuit and configured to reduce the EMI to the system. The electricity supply of the EMI 11 is transformed from AC to DC supply by the rectification module 12. The On/Off power supply module 13 then gives a DC voltage to the CCFL (Cold Cathode Fluorescent Lamp) driving module 14 and the RF power supply module 15. The CCFL driving module 14 controls the intensity and on/off of the CCFL. The RF power supply module 15 provides the electricity of the RF module 16. The RF module 16 receives the signal from the RF transmitter 10 (as shown in FIG. 1A) and gives signal to the CCFL driving module 14 to control the bulb. In this embodiment, the built-in module is integrated with the lamp.

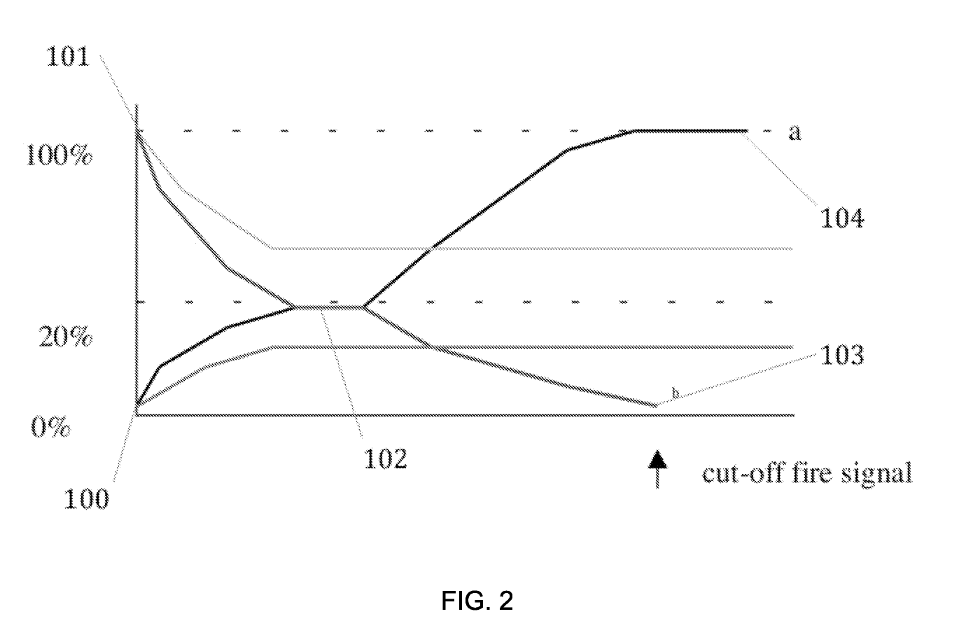

FIG. 2 illustrates the change of the light intensity of the lamp when the light intensity is being adjusted by the apparatus for controlling the light intensity of a lamp in the embodiment as depicted in FIG. 1B. Referring to FIG. 2, with the design of the dimming control method, the intensity of the lamp being controlled is varying before it is stable. It includes three levels of intensity, namely the current level, the preset level, and the adjusted level. The current and adjusted levels are any point that are higher than or equal to the point of cut-off percentage 103. The preset level 102 is a reference percentage that is higher than the point of cut-off percentage 103, and it is preset in the system. It is 20% in this embodiment as shown in FIG. 2. Therefore, there are two states varying from the current level 101 to the preset level 102 and from preset level 102 to the adjusted level 103 or 104.

Referring to FIG. 2, the dimming control starts at a point 100 which prevents the unstable situation of the bulb flashing (the bulb flashes that can be recognized by human eyes) from happening The light intensity of the lamp at the point 100 is in the range of 10%-20% of the maximum intensity of the lamp. The points 100 and 103 are the levels of starting and ending of electricity supply respectively. In the initial state, as the system is ON, the light intensity increases from the point 100 to the point 102. With no adjustment, the intensity keeps on this preset value. When the adjustment starts, one second is given as an ignorance time interval for controlling. Then the light intensity increases from the point 102 to the point 104 or from the point 102 to the point 103 in another one second.

In another state, as the current intensity is on any point ranging from the point 100 to the point 101, after making adjustment with the ignorance time interval of one second, the intensity changes from the current point to the point 102 and keep the intensity on the point 102 for another one second. Then the intensity changes from the point 102 to the adjusted level, which is in the range from the point 100 to the point 101.

In the termination state, as the system switches off, the light intensity changes after the ignorance of one second, from the current point to the point 102 in one second and from the point 102 to the point 103 in another one second.

All the intensity changes are in gradient, which means that in any particular time interval, the intensity is changed in only one direction (only increases or only decreases).

While the present patent application has been shown and described with particular references to a number of embodiments thereof, it should be noted that various other changes or modifications may be made without departing from the scope of the present invention.

What is claimed is:

1. An apparatus for controlling the light intensity of a lamp comprising:
a remote control unit, the remote control unit comprising a RF transmitter for transmitting a RF signal based on a user input; and
a built-in module integrated with the lamp, the built-in module comprising a RF receiving module configured for receiving the RF signal from the remote control unit and a lamp driving module controlled by the RF receiving module and configured for controlling the light intensity of the lamp based on the RF signal; wherein:
in adjusting the light intensity of the lamp, the built-in module is configured to change the light intensity from a current level to a preset level and then from the preset level to an adjusted level.

2. The apparatus for controlling the light intensity of a lamp of claim 1, wherein the built-in module is configured to change the light intensity from the current level to the preset level over a predetermined time interval and to change the light intensity from the preset level to the adjusted level over the predetermined time interval.

3. The apparatus for controlling the light intensity of a lamp of claim 1, wherein the built-in module is configured to change the light intensity after a predetermined time interval of ignorance.

4. The apparatus for controlling the light intensity of a lamp of claim 1, wherein the built-in module is configured to keep the light intensity at the preset level for a predetermined time interval before changing the light intensity from the preset level to the adjusted level.

5. The apparatus for controlling the light intensity of a lamp of claim 1, wherein the built-in module is configured to change the light intensity in only one direction in any particular time interval.

6. The apparatus for controlling the light intensity of a lamp of claim 1, wherein the current level and the adjusted level are higher than or equal to a cut-off level and the preset level is higher than the cut-off level.

7. The apparatus for controlling the light intensity of a lamp of claim 1, wherein the built-in module is configured to change the light intensity from a starting intensity level that is equal to 10% to 20% of the maximum intensity of the lamp.

8. A method for controlling the light intensity of a lamp comprising:
transmitting a RF signal based on a user input through a remote control unit;
receiving the RF signal with a RF receiving module; and
controlling the light intensity of the lamp based on the RF signal with a lamp driving module controlled by the RF receiving module, the RF receiving module and the lamp driving module forming a built-in module integrated with the lamp; wherein:
the light intensity of the lamp is changed from a current level to a preset level and then from the preset level to an adjusted level.

9. The method for controlling the light intensity of a lamp of claim 8, wherein the light intensity is changed from the current level to the preset level over a predetermined time interval, and is changed from the preset level to the adjusted level over the predetermined time interval.

10. The method for controlling the light intensity of a lamp of claim 8, wherein the light intensity is changed after a predetermined time interval of ignorance.

11. The method for controlling the light intensity of a lamp of claim 8, wherein the light intensity is kept at the preset level for a predetermined time interval before being changed from the preset level to the adjusted level.

12. The method for controlling the light intensity of a lamp of claim 8, wherein the light intensity is changed in only one direction in any particular time interval.

13. The method for controlling the light intensity of a lamp of claim 8, wherein the current level and the adjusted level are higher than or equal to a cut-off level and the preset level is higher than the cut-off level.

14. The method for controlling the light intensity of a lamp of claim 8, wherein the light intensity is changed from a starting intensity level that is equal to 10% to 20% of the maximum intensity of the lamp.

15. An apparatus for controlling the light intensity of a lamp comprising:
a remote control unit, the remote control unit comprising a RF transmitter for transmitting a RF signal based on a user input; and
a built-in module integrated with the lamp, the built-in module comprising a RF receiving module configured for receiving the RF signal from the remote control unit, a lamp driving module controlled by the RF receiving module and configured for controlling the light intensity of the lamp based on the RF signal, and a power supply module configured for supplying a DC voltage to the RF receiving module and the lamp driving module; wherein:
in adjusting the light intensity of the lamp, the built-in module is configured to change the light intensity from a current level to a preset level and then from the preset level to an adjusted level.

16. The apparatus for controlling the light intensity of a lamp of claim 15 further comprising a rectification module connected to the power supply module and configured for transforming an AC power supply to a DC power supply.

17. The apparatus for controlling the light intensity of a lamp of claim 16 further comprising an electromagnetic interference module connected with the rectification module and configured to reduce the electromagnetic interference to the apparatus.

18. The apparatus for controlling the light intensity of a lamp of claim 17, wherein the built-in module is configured to change the light intensity from the current level to the preset level over a predetermined time interval, to change the light intensity from the preset level to the adjusted level over the predetermined time interval, to change the light intensity after a predetermined time interval of ignorance, and to keep the light intensity at the preset level for a predetermined time interval before changing the light intensity from the preset level to the adjusted level.

19. The apparatus for controlling the light intensity of a lamp of claim 17, wherein the built-in module is configured to change the light intensity in only one direction in any particular time interval.

20. The apparatus for controlling the light intensity of a lamp of claim 17, wherein the current level and the adjusted level are higher than or equal to a cut-off level, the preset level is higher than the cut-off level, and the built-in module is configured to change the light intensity from a starting intensity level that is equal to 10% to 20% of the maximum intensity of the lamp.
